(19) United States
(12) Patent Application Publication
(10) Pub. No.: US 2007/0115942 A1
(43) Pub. Date: May 24, 2007

(54) DEPLOYABLE VOICE OVER INTERNET PROTOCOL (VoIP) COMMUNICATION SYSTEM

(76) Inventors: James Keith Money, Heathrow, FL (US); Phillip James DuMas, DeLand, FL (US)

Correspondence Address: WILDMAN HARROLD ALLEN & DIXON, 225 WEST WACKER DRIVE, SUITE 2800, CHICAGO, IL, 60606, US

(21) Appl. No.: 11/468,617

(22) Filed: Aug. 30, 2006

Related U.S. Application Data
(63) Continuation-in-part of application No. 11/383,899, filed on May 17, 2006.
(60) Provisional application No. 60/715,710, filed on Sep. 7, 2005.
(60) Provisional application No. 60/754,120, filed on Dec. 27, 2005.
(60) Provisional application No. 60/775,687, filed on Feb. 22, 2006.

(51) Int. Cl. H04L 12/66

(52) U.S. Cl. 370/352

(57) ABSTRACT

A deployable Voice over Internet Protocol (VoIP) system for providing VoIP communication to communication devices via a data network is provided. Wireless telephonic devices are used for wireless communication with an extended range antenna coupled with a base station. VoIP adapters, coupled with the base station, provide telephonic lines upon obtaining network connectivity. A power supply provides power to the base station and the VoIP adapters with the base station, VoIP adapters and power supply being fixedly housed in a portable case.

### CROSS REFERENCE TO RELATED APPLICATIONS

This application claims priority from U.S. Provisional Provisional Application No. 60/715,710 filed on Sep. 7, 2005, U.S. Provisional Application No. 60/754,120 filed on Dec. 27, 2005 and U.S. Provisional Application No. 60/775,687 filed on Feb. 22, 2006.

This application is a continuation-in-part of U.S. patent application Ser. No. 11/383,899 filed on May 17, 2006 the entirety of which if hereby incorporated by reference.

### FIELD OF INVENTION

The present invention relates to voice communication devices operating in wireless broadband networks and more particularly to systems employing wireless handset devices that utilize Voice over Internet Protocol (VoIP) for voice communication.

### BACKGROUND OF THE INVENTION

VoIP technology allows voice and facsimile communications to take place over the Internet or other network protocols both within the same network and on traditional fixed telephone infrastructure. Voice and data communications over networks may be provided when fixed infrastructure provides the necessary power and network connectivity to users in relatively fixed locations. But for mobile network users such as first responders, law enforcement officers and other emergency personnel, known networking solutions do not necessarily provide the same reliable broadband network connectivity. Particularly with environmental disasters, such as hurricanes, chemical spills, floods, and the like, when fixed network infrastructure may be damaged or inaccessible, the ability to reliably send and receive voice communications and other data is important.

There is a need for a reliable, portable and quickly deployable solution that can securely and seamlessly send and receive voice communications via a wireless network to internal users as well as external telephony clients. It is desirable that such voice communications can be made from remote users and in a variety of terrain and environmental conditions. Ideally, this solution would be independent of network topology, having the ability to transparently integrate with mobile, fixed, mesh, and structured network environments, using various network-configurable protocols. It would also be advantageous if this solution could be installed or set up by a user without networking expertise.

### BRIEF DESCRIPTION OF THE DRAWINGS

FIG. 1 is a network diagram illustrating disparate networks formed in accordance with one embodiment of the present invention.

FIG. 2A is a system diagram illustrating a front perspective view of components utilized in forming the network of FIG. 1.

FIG. 2B is an exploded front perspective view of a control unit shown in FIG. 2A.

FIG. 2C is a rear view of the control unit of FIG. 2B.

FIG. 2D illustrates the connections between various components in the system of FIG. 2A.

FIG. 3 illustrates the software components residing on the network management and application servers of FIGS. 2A-2D.

FIG. 4 is a flow chart illustrating the steps for sending communications from a wireless client using the system of FIG. 2A.

FIG. 5 is a flow chart illustrating the steps for sending communications from a wired client using the system of FIG. 2A.

FIG. 6 is a flow chart illustrating the steps for establishing and sending communications over a virtual private network using the system of FIG. 2A.

FIG. 7 is a system diagram illustrating an example VoIP communication system for communication with an external network.

FIG. 8 illustrates an example patch panel for use in the VoIP communication system of FIG. 7.

FIG. 9 is a block diagram illustrating an example of various components of the VoIP communication system of FIG. 7 for housing within a portable case.

FIG. 10 illustrates an alternative example of a VoIP communication system.

FIG. 11 is a block diagram illustrating an example of various components of the VoIP communication system of FIG. 10.

### DETAILED DESCRIPTION

A system enables the exchange of data, voice and video securely across disparate networks, even when traditional network infrastructure is unavailable, damaged or inaccessible. In one embodiment, a control unit comprising a network management server, allows users to communicate across a plurality of sub-networks, including private networks, such as wired and wireless networks within a local area and public networks like the Internet. Users can also communicate over a virtual private network (“VPN”), via the Internet. In the event of a nature disaster, where cell towers, public switched telephone network and power lines are down, the system can be deployed to establish a local area network for wired and wireless users alike. The system can be configured and deployed for use rapidly, between about 10.0 minutes and about 40.0 minutes, 20.0 minutes to about 40.0 minutes and more particularly between about 10.0 minutes and 20.0 minutes for example.

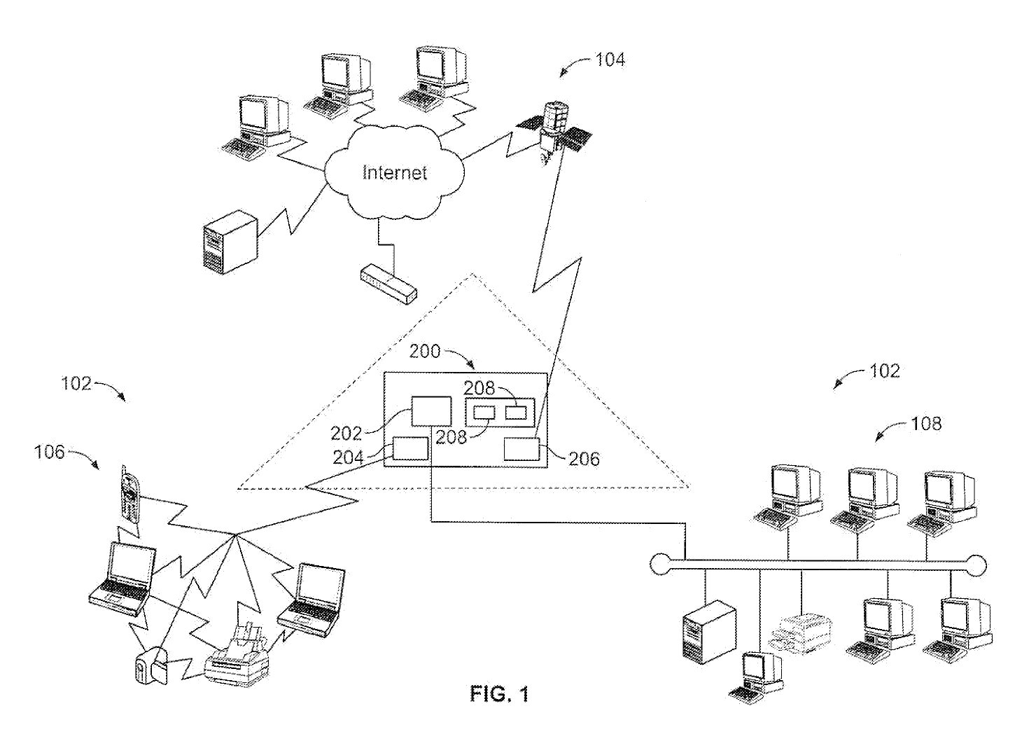

As shown in FIG. 1, the system provides communication and services between various network communication devices across both private and public networks 102 and 104. The system establishes a local area private network 102 comprising wireless and/or wired sub-networks 106 and 108. Wireless sub-network 106 may comprise a mesh network and a logical wireless network for communication over Ethernet connections.

A mesh network is a network that routes data between nodes in the absence of a centralized server used for authentication, with self-authentication occurring between nodes in the network. Mesh networks provide continuous connections and reconfiguration around blocked paths by hopping from node to node in the most efficient path possible (by searching for the shortest path between two points) until connections can be established. Mesh networks are self healing, which means that the network can still operate even when a node or other connection is inoperable. Each node within the network authenticates the others. The nodes may, for example, be network communication devices, routers or network access points.

Each of wireless and wired sub-networks 106 and 108 may be designated with its own IP address space. For example, wireless sub-net 106 may be designated with 10.0/16 addresses and wired sub-net 108 may be designated with 192.168/16 addresses.

Wired and wireless users within the wireless and wired networks 106 and 108 can advantageously communicate with one another across virtually any network protocol, including without limitation Transmission Control Protocol/Internet Protocol (TCP/IP), User Datagram Protocol (UDP), Internet Packet Exchange (IPX), Sequenced Packet Exchange (SPX), etc. In addition, these users can quickly gain access to the Internet and use the Internet to communicate over a VPN.

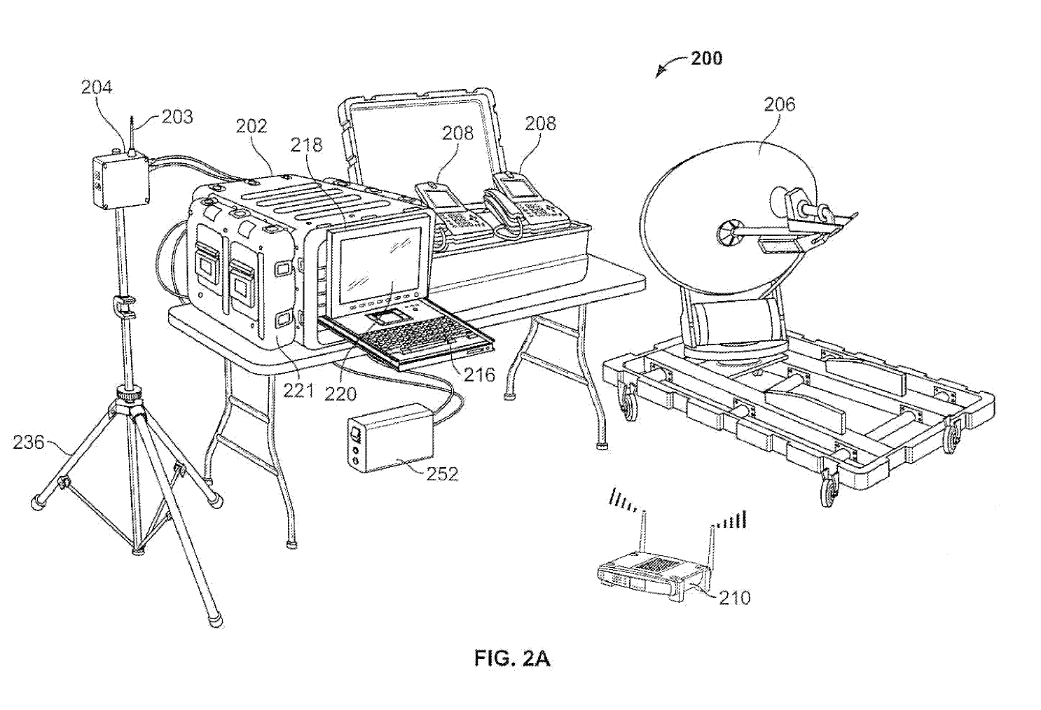

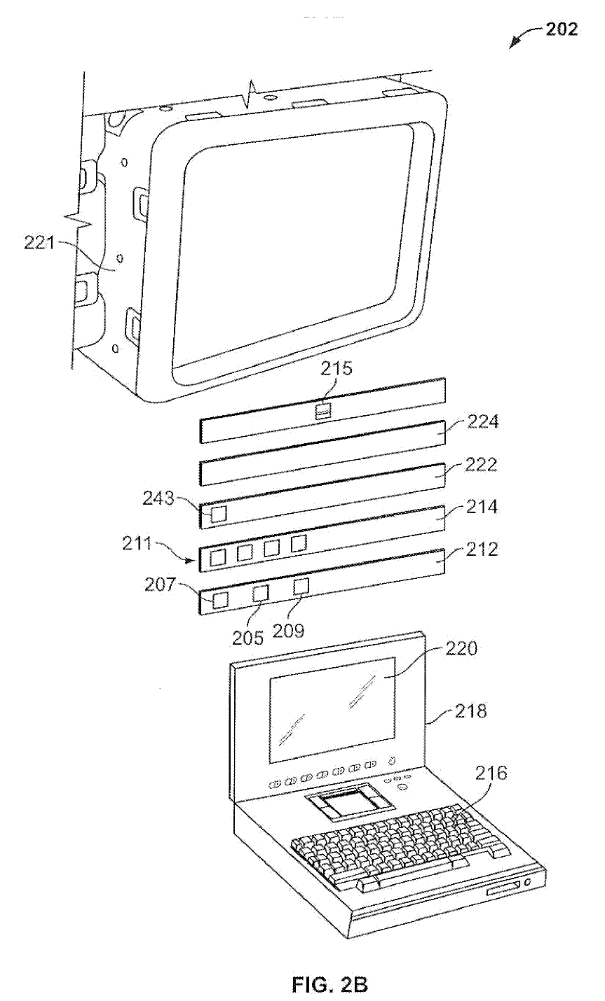

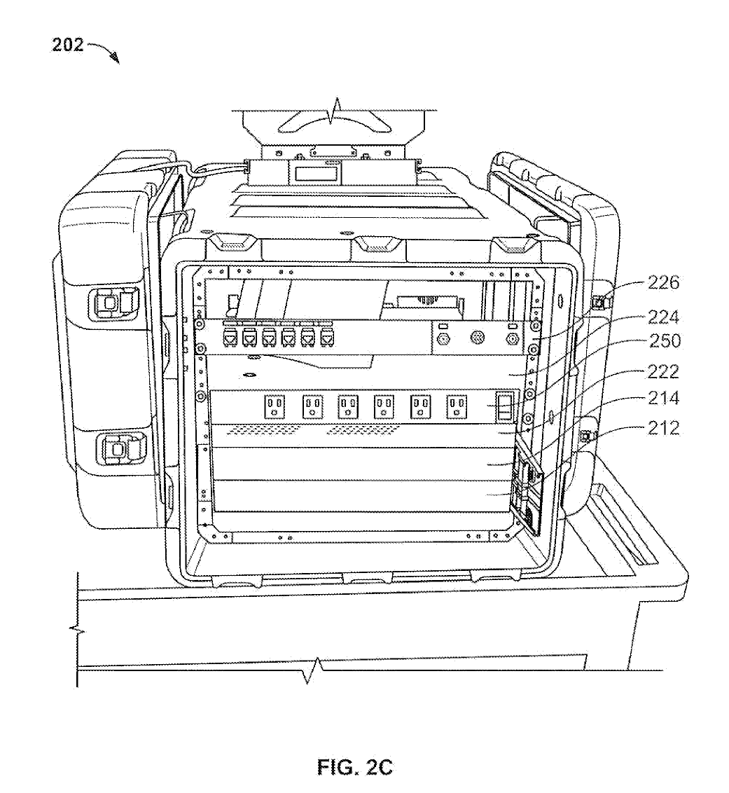

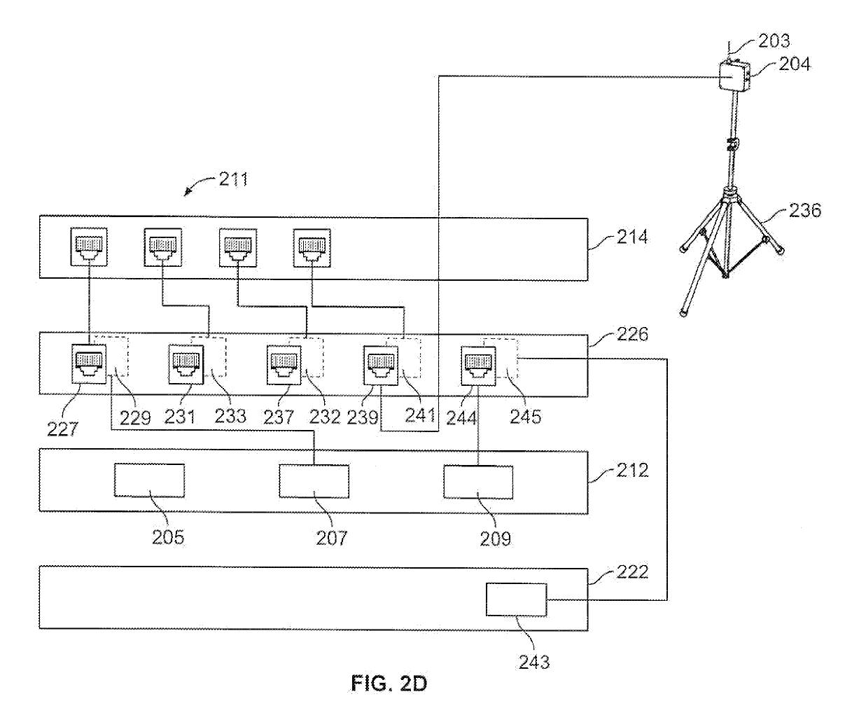

FIG. 2A illustrates one embodiment of the system 200 of the present invention, which comprises control unit 202, access point 204, satellite dish 206 and network communication devices 208. The system may further comprise a plurality of wireless routers 210.

With reference to FIG. 2A-2D, control unit 202 may comprise network management server 212, application server 214, switch 215, input device 216, monitor 218 comprising display screen 220, satellite dish alignment component 222, satellite data conversion component 224, patch panel 226 comprising various connection ports hard wired into network management and application servers 212 and 214 and power strip 250. As described hereinafter, various connection cables, such as Ethernet cables, connect certain components within system 200 to one another.

The foregoing components of control unit 202 are typically mounted in a single rugged plastic case 221 and powered up through connection of power cable 250 to power source 252, such as a generator. The single rugged case may comprise dimensions between about 15.0 inches to about 25.0 inches in height, about 20.0 inches to about 30.0 inches in width and about 30.0 to about 40.0 inches in length. The case may comprise a pull-out rack for mounting the various components. One embodiment of case is available from Hardigg Industries, Inc. of South Deerfield, Mass. With the components mounted in the case, control unit typically weighs between about 100.0 pounds to about 200.0 pounds and more particularly between about 150.0 pounds to about 200.0 pounds. Thus, case 221, with control unit 202 positioned therein may be man-portable (capable of being physically carried by one to three men). Accordingly, control unit 202 may be packaged in a kit with instructions for assembling the system. The kit may comprise all or select components of control unit 202.

Network management server 212 is a device capable of managing and routing communications across disparate networks. Network management server 212 may comprise various network management and service sub-processes, described hereinbelow as well as certain network interface ports, including wired network interface 205 for communication with wired sub-network 108, wireless network interface 207 for communication with wireless sub-network 106 and Internet network interface 209 for communication with the Internet, via satellite dish 206. User may connect various wired devices to wired network interface, including computers, phones and the like. Network management server 212 may be a multi-purpose server running on a Linux operating system. The Linux operating system enables communication over different network protocols, including those network protocols listed above.

Application server 214 may operate on a windows based operating system and typically resides on wireless sub-network 106, with its own IP address. Application server 214 comprises four port switch 211, which connects in various ways to front and rear ports on patch panel 226 and to access point 204 for wireless sub-network 106 access. Application server 214 may further comprise various application sub-processes.

Switch (hidden from view) is used to control network management and application servers 212 and 214 with a single keyboard, monitor and mouse. Switch may be a keyboard video mouse switch (“KVM switch”). Alternatively, switch 215 may accomplish the same purpose through software that forwards the necessary input over standard network connections. Suitable examples include Synergy and MaxiVista available from Bartels Media.

Satellite dish alignment component 222 works in conjunction with satellite data conversion component 224 to align satellite dish 206 with a satellite (not shown) and convert the satellite signal into a usable protocol by system 200. The satellite provides a connection to the Internet. Satellite dish alignment component 222 typically comprises a Linux based computer with global positioning software and satellite dish port 243. One example is the alignment system available from TracStar Systems, Inc. of Orlando, Fla. Satellite data conversion component 224 can function like a TCP/IP standards compliant bridge, providing an interface between the satellite and the Internet. In essence, data conversion component 224 converts data received on an Ethernet port into a radio-frequency format for sending to the satellite. Satellite data conversion component 224 may be a Tachyon indoor unit (IDU), available from Tachyon Networks, Inc. of San Diego, Calif.

Access point 204, comprising antenna 203, is adapted to provide network communication devices 208 within its coverage area access to wireless and wired network services, serving as the principal network management interface to associated network communication devices 208 and wireless routers 210. In one embodiment, the term access point, as used herein, means a bridge between the wired and wireless networks. Access point 204 may also serves as a bridge between radio-frequency based communications and Ethernet based communications. In general, access point 204 comprises a first network interface card for radio-frequency transmissions—for example a mesh network memory card to communicate over a mesh network—and a second network interface card to communicate over Ethernet connections. In one embodiment, access point 204 is an IAP7300 Intelligent Access Point available from Motorola, Inc. of Schaumberg, Ill., which contains two or more 802.11 compliant radios and two or more mesh mobile broadband radios. In one embodiment, one set of radios operates in the unlicensed, 2.4 GHz band and the other set operates in the licensed, 4.9 GHz public safety band.

Instead of permanently affixing access point 204 on top of water towers, radio towers or light poles, it may be placed on tripod 236 for tactical deployment and ease of redeployment without dissolution of networks 102 and 104. Tripod 236 may be a four meter mast system rated to withstand up to 120 m.p.h. wind loads.

Satellite dish 206 may be auto-deployed to provide Internet access for temporary field locations, emergency response teams and special events. Dish 206 may be deployed within about two to three minutes. One embodiment of satellite dish 206 is available from Tachyon Networks, Inc. This embodiment automatically aligns with an airborne satellite through satellite dish alignment component 222. Satellite dish 206 may also be manually aligned with satellite, though this process takes additional time to properly deploy. Satellite dish may be mounted on a platform comprising wheels for ease of deployment and transport.

Network communication devices 208 may be laptop computers, personal computers (PC), wireless telephones, personal digital assistants (PDA), video cameras, or any other device capable of receiving and/or transmitting voice, video or data. In one embodiment, for example, wireless analog phones run in the 900 MHz or 5.8 GHz range, with base receiving stations and chargers located in a hardened case connected to a wireless element to communicate across the network. The case may comprise connectors for power and data cables, for connection to patch panel 226. In another embodiment, portable laptop computers comprise communication software application described in co-pending, co-owned U.S. patent application Ser. No. 11/383,775, entitled “Apparatus and Method for Dynamically Updating and Communicating Within Flexible Networks,” of Dumas, et al., the entire disclosure of which is hereby incorporated by reference. These portable laptop computers can communicate over wireless sub-network 106 through mesh enabled network communication architecture.

The system may further comprise a plurality of wireless routers 210. Routers 210 may be strategically placed to increase network coverage in large geographic areas. Through the use of routing tables, routers 210 allow communications to travel in the most efficient manner from one point to another within wireless network 106. Use of routers 210 advantageously provides users with the capability of tapping into a fully enabled and scalable mesh network, with authentication at the router 210 level.

A plurality of Ethernet cables may be utilized to establish connections among the components and networks within system 200. Generally, speaking, the connections provide a path for data between applications, servers and the Internet. Although such connections may be configured in various ways, a preferred framework is illustrated in FIG. 2D and described hereinafter. Referring now to FIG. 2D, patch panel 226 comprises a plurality of front and rear ports, with each front port electrically connected to a corresponding rear port. Specifically, patch panel 226 comprises front and rear application server ports 227 and 229, first front and rear phone port 231 and 233, second front and rear phone ports 235 and 237, front and rear access point ports 239 and 241, and front and rear network management server ports 244 and 245.

Front application server port 227 connects to four port switch 211 while rear application server port 229 connects to wireless network interface 207 on network management server 212. In this way, application server 214 connects to wireless network 106 for sending and receipt of data over Ethernet connections.

First and second front phone ports 231 and 235 connect to base stations of network communication devices 208 used in the field. First and second rear phone ports 233 and 237 connect to four port switch 211. These connections enable communication over wireless network 106.

Front access point port 239 connects to access point 204, while rear access point port 241 connects to four port switch 211. The connection of access point 204 to control unit 202 in this way enables conversion of radio frequency based communications into Ethernet based communications for transmission of data over wireless network 106.

Front management server port 244 connects to Internet network interface port 209 on network management server 212 while rear management server port 245 connects to satellite dish port 243 on satellite dish alignment component 222. These connections are used for communications over the Internet.

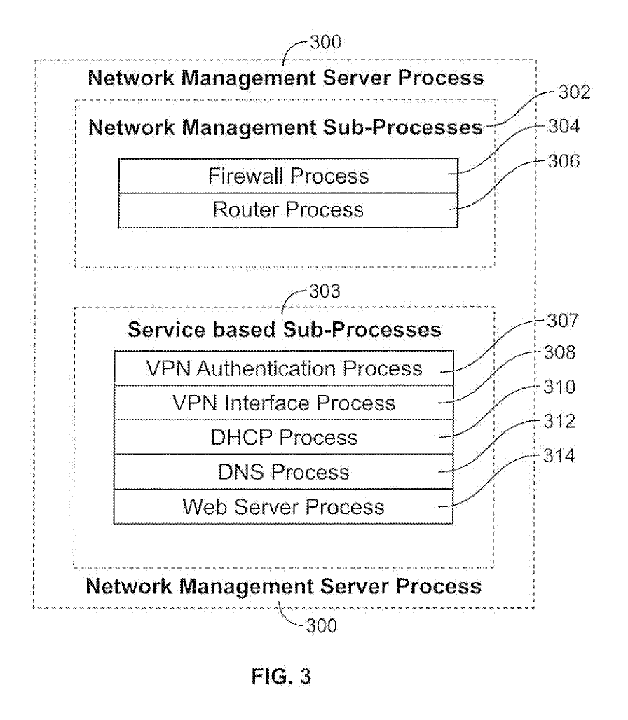

As shown in FIG. 3, network management server 212 comprises network management server process 300, which comprises various network management sub-processes 302, including firewall process 304 and routing process 306 as well as various service-based sub-processes 303 including, VPN authentication process 307, VPN interface process 308, dynamic host configuration protocol (“DHCP”) process 310, domain naming system (“DNS”) process 312 and web server process 314. Firewall process 304 filters unwanted incoming and outgoing communications from control unit 202, typically by validating that the source address corresponds to the particular network on which the communication was received and only allowing specific port numbers from the internet Routing process 306 directs communications to the appropriate network interface. VPN authentication process 307 determines whether VPN clients are permitted network users. VPN interface process 308 provides a connection or interface to Internet for virtual private network connectivity. DHCP process 310 dynamically assigns IP addresses to devices on the network. DNS process 312 transforms a host name, such as an Internet Uniform Record Locator (URL), into an IP address by accessing the host via the satellite link. By caching the retrieved IP address locally, DNS process 312 decreases traffic over the satellite link when subsequent requests for the same host are made. Web server process 314 stores and provides information to network communication devices within the local area network (e.g., list of local telephone numbers). Network management server 212 may also comprise Mesh manager software for communicating over the mesh network.

Application server 214 may also comprise various application processes. Examples include video and audio sub-processes for video and audio communication and file transfer sub-process for transferring files within the networks.

Having described the components of system 200, we turn now to the stepwise sequence for assembly of system 200. As previously mentioned, system 200 is capable of being assembled with 10-40 minutes. Control unit 202 is positioned on a flat sturdy surface such that the operator has access to its front and rear. (At this point, the connections between the various ports on patch panel 226, network management and application servers 212 and 214 and access point 204 are already established). A power cable for control unit 202 is plugged into power strip 250 connected to a power generator 252, such as an AC power source. Satellite dish 206 is positioned on a level surface in alignment with the approximate location of a Geosynchronous satellite. Connection cables are secured to satellite dish 206 and appropriate locations on control unit 202. If phones are being used, other connection cables, such as Ethernet Cat-5 cables, can be used to connect the phones to first and second front phone ports 231 and 235 within patch panel 226. Tripod 236 is set up and access point 204 positioned on top thereof. Antenna 203 is connected to access point 204 and connection cables (Ethernet Cat-5) are secured to access point 204 and front access point port 239. Power cables connect access point 204 to power strip 250 or the AC power source. Control unit 202 is started by powering on network management and application servers 212 and 214 as well as satellite dish alignment component 222. Input device 216 and monitor 218 are pulled out of case and locked into position.

After assembly of system 200, communication across the disparate sub-nets may occur. Prior to communication, however, clients are typically authenticated. Clients operating in the wired and wireless network, for example, are authenticated through access point 204 or wireless router 210. Each individual client forwards its media access control (“MAC”) addresses to access point 204 along with a request for DHCP services to network management server 212. If the MAC addresses are recognized, access point 204 informs network management server 212, which forwards an IP address back through access point 204 and on to the client. If the client is a VPN user, a request for authentication is sent to network management server 212, where VPN authentication process 307 determines whether the client is a permitted user. VPN authentication may occur in various ways, via static keys, username and password, etc.

Once clients have been authenticated, communication adheres to a general framework that may be adjusted depending on the source/destination and nature of the communication being sent. Generally, the destination client of the communication is determined as one of the first steps. If the destination client employs the same type of device as the source client, the communication is routed directly thereto without traveling through network management server 212. Otherwise, the communication is sent to network management server 206, where firewall process 304 filters it according to the firewall rules in place. Router process 306 then directs the communication to the appropriate network interface for receipt by the destination client. Depending on the nature of the communication, the destination may respond through control unit 202 in a similar manner.

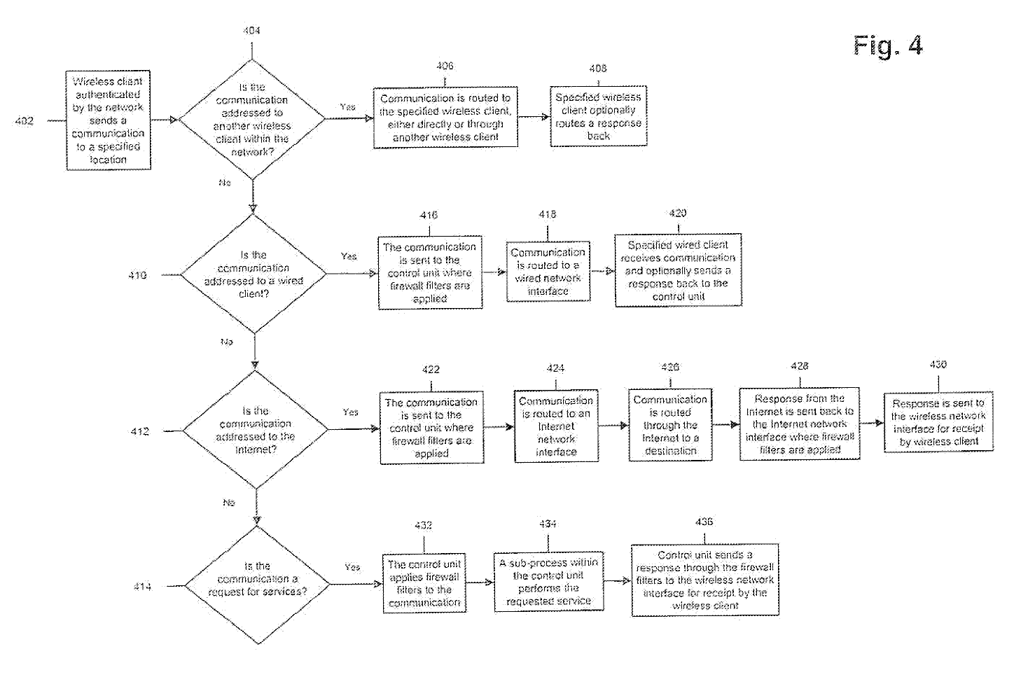

FIG. 4 illustrates the steps for sending communications from a wireless client using system 200. In step 402, the wireless client sends a communication packet to a specified location. The ultimate destination and nature of the communication packet govern next steps.

In step 404, the system ascertains whether the communication packet is addressed to another wireless client in the network. If so, in step 406, the communication packet is routed directly to that client or through another wireless client in the network. The receiving client, in step 408, optionally sends a response back. If the communication packet is not addressed to a wireless client, the system checks to see if the communication packet is addressed to a wired client (step 410), the Internet (step 412) or includes a request for a service by control unit 202 (step 414).

If the communication packet is addressed to a wired client, it is sent to control unit 202, where, in step 416, firewall process 304 filters the communication packet. In particular, firewall process 304 verifies that the source and destination IP addresses correspond to the particular network on which the communication was received and processes a set of configurable rules based on IP address, port protocol, application, etc. In step 418, routing process 306 routes the communication packet to the wired network interface, typically an Ethernet port connected to the wired network. In step 420, the wired client receives the communication packet and optionally sends back a response, which begins the process anew.

If the communication packet is addressed to the Internet (e.g., a mail server or URL), in step 422, it is sent to control unit 202 where firewall process 304 checks the IP address of its source. Since the ultimate destination on the Internet is not always known, firewall process does not necessarily check the destination IP address. In step 424, routing process 306 routes the communication packet to Internet gateway network interface 209, typically an Ethernet port connected to the Internet. In step 426, the communication packet is routed through the Internet to its destination. More specifically, the packet is routed through satellite data conversion component 224 and up to the airborne satellite for connectivity to the Internet. In step 428, a response from the Internet is sent back to Internet network interface 209 via satellite data conversion component 224 so firewall process 304 can ensure that the destination of the response corresponds to the particular network on which the communication was received. In step 430, routing process 306 routes the response to the wireless network interface for receipt by the wireless client.

If the communication packet comprises a request for services by network management server 212, in step 432, firewall process 304 checks the source IP address. In step 434, one of the service-based sub-processes 303 performs the requested service. In step 436, a response is sent through the firewall filters, to verify the IP address of the destination within the network, and on to wireless network interface 207 for receipt by the destination that initially sent the request.

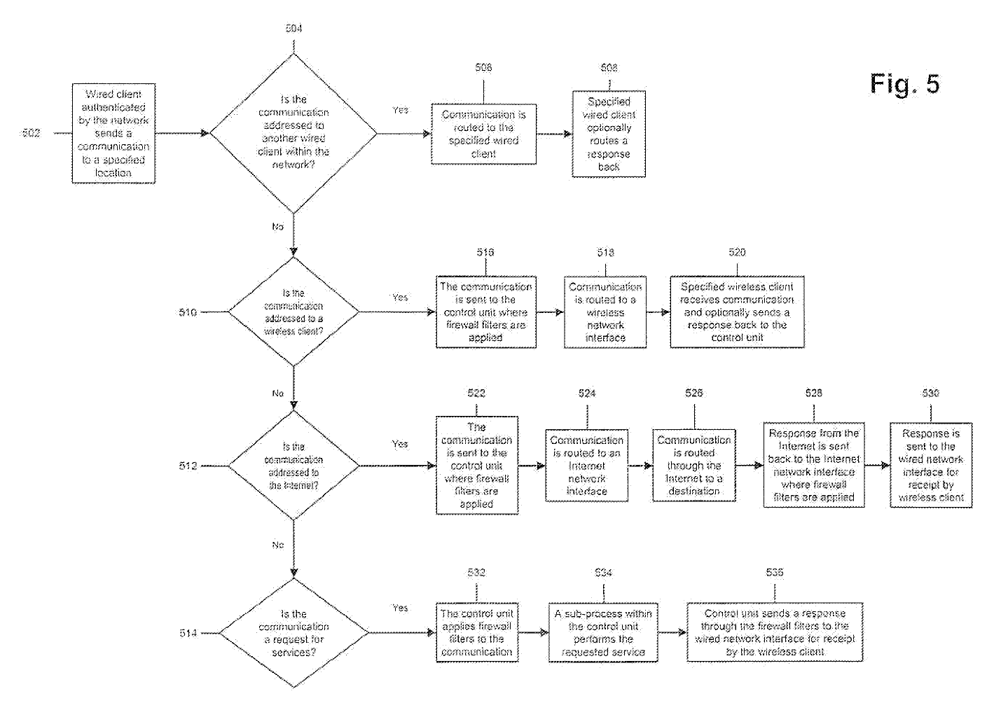

FIG. 5 illustrates the steps for sending communications from a wired client using system 200. In step 502, the wired client sends a communication packet to a specified location. Once again, the ultimate destination and nature of the communication packet govern next steps.

In step 504, the system ascertains whether the communication packet is addressed to another wired client in the network. If so, in step 506, the communication packet is routed to that client within the network. The receiving wired client, in step 508, optionally routes a response back. If the communication packet is not addressed to a wired client, the system checks to see if the communication packet is addressed to a wireless client (step 510), the Internet (step 512) or includes a request for a service by control unit 202 (step 514).

If the communication packet is addressed to a wireless client, it is sent to control unit, where, in step 516, firewall process 304 filters the communication packet. Here again, firewall process 304 verifies that the source and destination IP addresses correspond to the particular network on which the communication was received. In step 518, routing process 306 routes the communication packet to wireless network interface 207, typically an Ethernet port corresponding and connected to wireless network 106. In step 520, the wireless client receives the communication packet and optionally sends back a response, which begins the process anew.

If the communication packet is addressed to the Internet (e.g., a mail server or URL), in step 522, it is sent to control unit 202 where firewall process 304 checks the source IP address. Prior to sending, the originator of the packet will probably have retrieved the destination address through a DNS lookup, which will be fulfilled by control unit 202 via DNS process 312. The DNS request will be fulfilled from a local cache if possible, limiting traffic to local network. In step 524, routing process 306 routes the communication packet to Internet gateway network interface 209, typically an Ethernet port corresponding and connected to the Internet. In step 526, the communication packet is routed through the Internet to its destination. More specifically, after receipt by network interface 209, the packet is routed up to the satellite for connectivity to the Internet. In step 528, a response from the Internet is sent back to Internet network interface 209 and firewall process 304 ensures that the destination of the response is authenticated. In step 530, the response is sent to wired network interface 205, for receipt by the wired client.

If the communication packet comprises a request for services by network management server 212, in step 532, firewall process 304 verifies that the source IP address corresponds to the particular network on which the communication was received. In step 534, one of the service-based sub-processes 303 performs the requested service. In step 536, a response is sent through the firewall process 304, and on to wired network interface 205 for receipt by the client that initially sent the request.

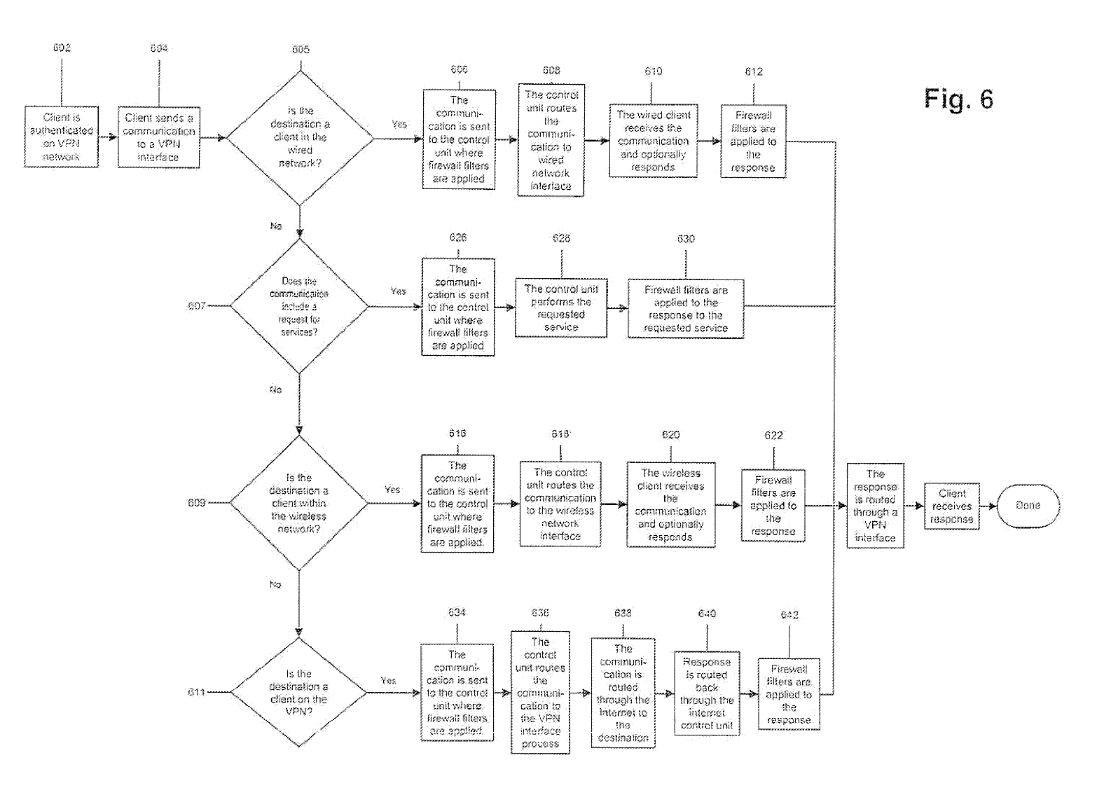

FIG. 6 illustrates the steps for sending communications over a virtual private network. In step 602, a client, such as a client within wireless or wired sub-nets 106 and 108 or a client outside the local area network, is authenticated by VPN authentication process 307 on network management server 210. In step 604, the client sends a communication to VPN interface process 308, also residing on network management server 210. The system checks to see if the communication packet is addressed to a wired client (step 605), a wireless client (step 609) or another VPN client (step 611) or includes a request for a service by control unit 202 (step 607).

If wired network 108 is the destination, in step 606, firewall process 304 filters the communication by ensuring that the IP addresses of the source and the destination correspond to the particular network on which the communication was received. In step 608, routing process 306 forwards the communication to the wired network interface. In step 610, the wired client receives the communication and can respond. In step 612, firewall process 306 filters the response by checking the IP addresses of the source and destination. The response is forwarded through VPN interface process 308 for receipt by the client.

If wireless network 106 is the destination, in step 616, firewall process 304 filters the communication. In step 618, routing process 306 forwards the communication to wireless network interface 207. In step 620, the wireless client receives the communication and may respond to the VPN client. In step 622, firewall process 304 filters the response. The response is forwarded through the VPN interface process 308 for receipt by the VPN client.

If the communication comprises a request for services by network management server 212, in step 626, firewall process 304 ensures that the source IP address corresponds to the particular network on which the communication was received. In step 628, one of service-based sub-processes 303 performs the requested service. In step 630, a response is filtered through firewall process 304, to verify the IP address of the destination corresponds to the particular network on which the communication was received. The response is forwarded through VPN interface process 308 for receipt by the VPN client.

If the destination is another VPN client, in step 634, firewall process 304 filters the communication by confirming that the source and destination IP addresses corresponds to the particular network on which the communication was received. In step 636, routing process 306 routes the communication to VPN interface process 308, which, in turn, routes the communication through the Internet to its destination in step 638. In step 640, a response is sent back through the Internet and ultimately filtered by firewall process 304 in step 642. The response is forwarded through VPN interface process 308 for receipt by the VPN client.

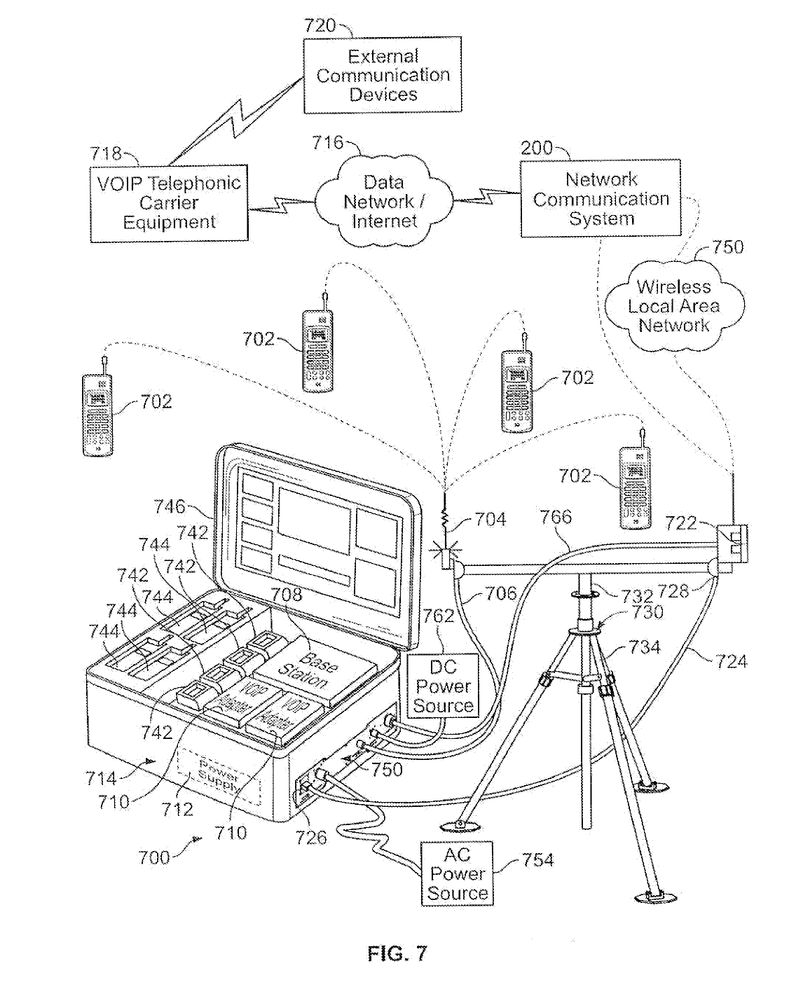

Referring to FIG. 7, one embodiment of a deployable Voice over Internet Protocol (VoIP) communication system 700 for providing VoIP communication to external communication devices via a data network, such as the Internet, is shown. Wireless telephonic devices 702 communicate in wireless fashion with antenna 704 coupled by antenna cable 706 to base station 708. Base station 708, in this example, is coupled for communication with VoIP adapters 710. VoIP adapters 710 provide analog telephone lines (for of each the wireless telephonic devices) upon obtaining network connectivity. Power supply 712 has a number of power outputs providing power to base station 708 and VoIP adapters 710. The VoIP communication system 700 may be configured as a deployable expansion kit to network communication system 200 in which various components of system 700 are held within portable case 714 for in-field set-up. Once VoIP communication system 700 is deployed for operation, voice and facsimile communication may be made to and from wireless telephonic devices 702 via network communication system 200 through data network 716 (such as the Internet, an intranet, or any other data network) for communication with VoIP telephonic carrier equipment 718 and eventually to outside users at external communication devices 720. VoIP communication system 700 is portable for quick deployment and set-up in a variety of terrains to provide wireless voice and facsimile communication to external communication devices 720 (such as telephones, computer devices, facsimile machines, or any other device capable of sending or receiving voice or data signals).

Network connectivity may be obtained at deployable VoIP communication system 700 in a number of ways. In the example seen in FIG. 7, VoIP adapters 710 are coupled with wireless router 722 by network cable 724 extending between network connection port 726 (in communication with VoIP adapters) and an Ethernet port 728 of the wireless router. Wireless router 722 provides wireless transmission of data packets received from VoIP adapters 710. Portable stand 730 having mast 732 and tri-pod base 734 may be used for mounting wireless router 722 and antenna 704 when VoIP communication system 700 is deployed and set-up for operation. Wireless router 722 may, for example, communicate with other network devices or nodes (not shown) of a wireless local area network 740 such as a mobile network, an ad-hoc network, or a mesh network. Wireless router 722 may be preconfigured for identification as a network device for communication within the wireless local area network 740. An example of a wireless router that may selectively be employed is an enhanced wireless router, model number EWR 6300 DC sold by Motorola, Inc. To obtain network connectivity, in this example, wireless router 722 may communicate with access point 204, FIG. 2A, of network communication system 200. As described above, control unit 202 is connected for communication with access point 204 and satellite dish 206. Satellite dish 206 is aligned to communicate with an airborne satellite, FIG. 1, providing network connectivity to the Internet or other data networks.

As seen with reference to FIGS. 1-6, network communication system 200, provides for the exchange of voice, video and data securely across disparate networks, even when traditional network infrastructure is unavailable, damaged or inaccessible. Network communication system 200, in this example, includes a control unit 202, FIG. 2B, comprising a network management server and allows users to communicate across various sub-networks, including private networks, such as wired and wireless networks within a local area and public networks such as the Internet. In the event of a nature disaster, where cell towers, public switched telephone network and power lines are down, network communication system 200, for example, may be deployed to establish a local area network for wired and wireless users alike. Network connectivity to VoIP communication system 700 may alternatively be accomplished by connecting network cable 724 (coupled with VoIP adapters) directly with control unit 202 of system 200. In particular, network cable 724 may be inserted at an appropriate VoIP expansion system port of control unit 202. VoIP data signals received at control unit 202 are able to be transmitted by satellite dish 206, FIG. 2A, to an airborne satellite for connectivity with the Internet. Additionally, network connectivity may be achieved at VoIP communication system 700, FIG. 7, by coupling the VoIP adapters 710 through network cable 724 to any alternative computer device (not shown) having connectivity to the Internet 716.

Antenna 704 of VoIP communication system 700, FIG. 7, provides wireless communication with wireless telephonic devices 702. Wireless telephonic devices 702, in this example, may be portable analog handsets for in-field use. However, other analog devices utilizing voice or facsimile communication may be employed. Antenna 704, may be, for example, a 900 mHz extended range antenna providing wireless communication with analog handsets 702 at distances in excess of one mile, and in certain instances in excess of two miles. Antenna cable 706 is attached to extended range antenna 704 and carries signals received from wireless telephonic devices 702 (such as 900 mHz frequency hopping time division multiple access (TDMA) signals) to base station 708. Base station 708 may, for example, be a private branch exchange (PBX) device.

As seen in FIG. 7, portable case 714, having hard plastic shell, is employed to house various components of VoIP communication system 700. Base station 708, VoIP adapters 710, and power supply 712 are fixedly housed within portable case 714. In this example, portable case 714 is packaged with communications electronics including base station 708 and VoIP adapters 710 in an upper section, with power supply 712 positioned in a lower cavity area of the case. The VoIP adapters 710 may be arranged in a daisy chain fashion, for example, with base station 708 and at least one of the VoIP adapters 710 being hardwired to power supply 712. Additionally, charging units 742 used for charging wireless telephonic devices 702 are also fixedly housed within portable case 714 and may be hardwired to power supply 712. Portable case 714 has compartments 744 formed in foam padding for storage of wireless telephonic devices 702 and associated spare telephonic batteries (not shown). An additional storage area is provided underneath the foam compartments 744 for storage of items such as network cable 724, antenna cable 706, power cables and the like when not in use. Portable case 714 is enclosed by lid 746 having storage for antenna 704 and related items.

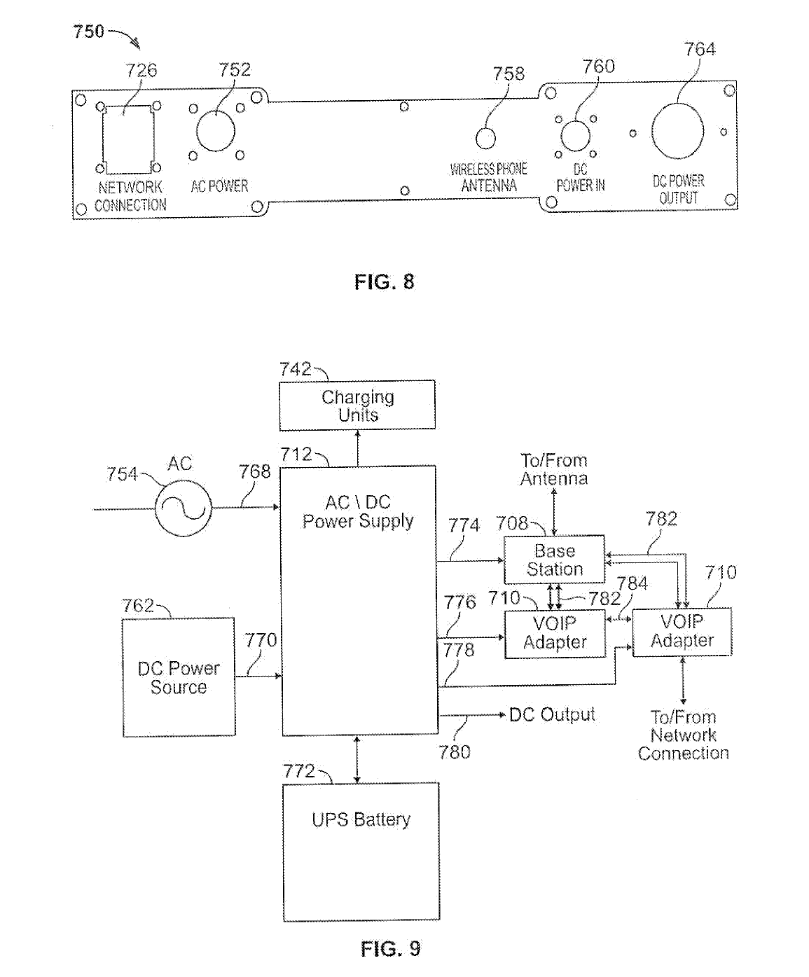

Patch panel 750 is placed at sidewall of portable case 714. As seen in FIGS. 7 and 8, patch panel 750 has a number of different ports. Network connection port 726 is coupled for communication with VoIP adapter 710 and is adapted to receive network cable 724 for connection with wireless router 722. AC power port 752 is coupled with power supply 712 to allow input of AC power received from an external AC power source 756, such as a commercial power source, generator, or inverter. Antenna port 758 is coupled with base station 708 providing connection with antenna cable 706 for transmission of telephonic signals to and from extended range antenna 704. DC power input port 760 provides for the input of DC power to power supply 712 received from an external DC power source 762. Various DC power sources may be used, for example, such as fuel cells, DC batteries (e.g. 12V battery), or solar power panels. Patch panel 750 also has DC power output port 764 coupled with power supply 712 to provide DC power, through power cable 766, to wireless router 722, or to selectively power other alternative devices.

Referring to FIG. 9, power supply 712 is shown having a number of power inputs for receipt of power from different sources and a number of power outputs providing DC power to various devices of the system 700. Power supply 712 may receive AC power at AC power input 768 from an external AC power source 754. DC power may alternatively be supplied at power supply 712 from various DC power sources 762, supplying DC power at DC power input 770. Additionally, uninterruptible power supply (UPS) battery 722 is coupled with power supply 712 to provide back up power for up to 30 minutes. Power supply 712 has multiple power outputs for providing DC power at the VoIP communication system 700. Each of the charging units 742 is hardwired to power supply 712 to receive power (e.g. 1.5 VDC, 1.5 A) from corresponding outputs of the power supply. Power supply output 774 provides power (e.g. 7 VDC, 1 A) to base station 708. Power supply outputs 776, 778 are coupled with and provide power (e.g. 12 VDC, 1 A) to VoIP adapters 710. Power supply 712 also has DC power output 780 providing power (e.g. 12 VDC, 1 A) to wireless router 722, FIG. 7, through power cable 724 connected at DC power port 764, FIG. 8.

As illustrated in FIG. 9, wireless voice signals are transmitted between base station 708 and wireless telephonic devices 722, for example, through antenna cable 706 and extended range antenna 704. Base station 708, for instance, is a wireless PBX analog phone base station coupled by telephone cables 782 to two dual-tone VoIP adapters 710 to provide four telephonic lines for each of the four wireless telephonic devices 702 as depicted in the example seen in FIG. 7. The VoIP adapters 710 employed may be analog telephone adapters (ATA) daisy chained in series through Ethernet cable 784 to provide voice communication to and from a network connection. The VoIP adapters 710, coupled with base station 708 by telephone cables 782, provide digital to analog phone lines upon obtaining network connectivity.

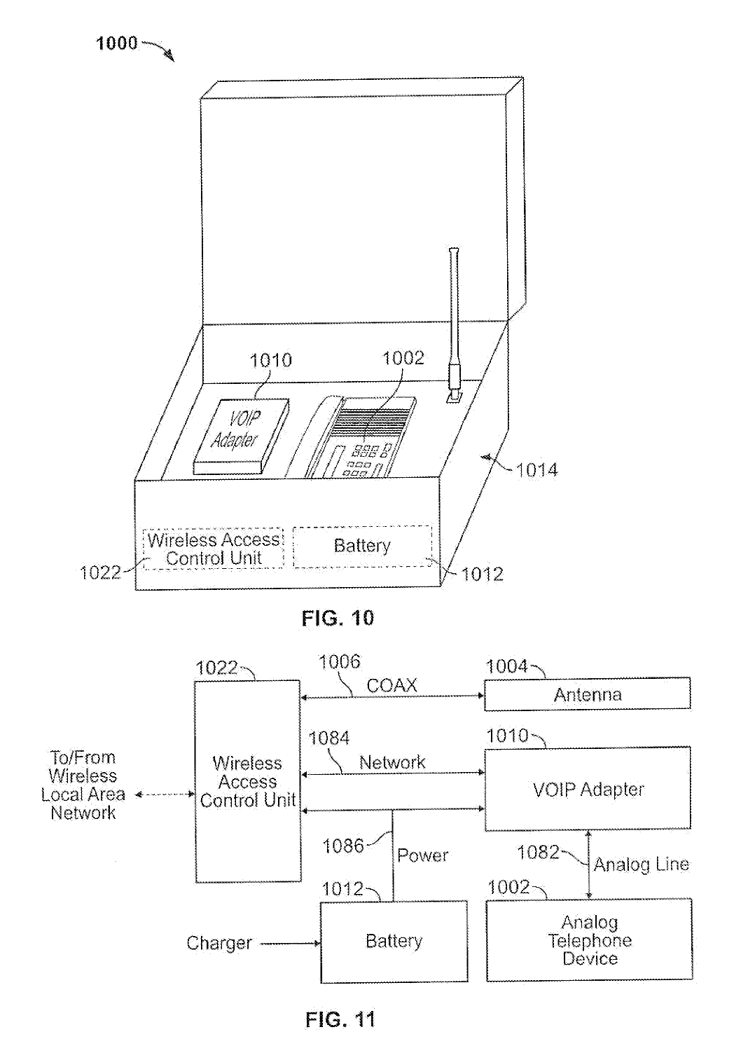

Referring now to FIGS. 10 and 11, an alternative example of a VoIP communication system 1000 is shown with telephonic device 1002 housed in portable case 1014. VoIP communication system 1000 may be used as a portable expansion kit to a wireless local area network having Internet connectivity to provide voice and facsimile communication. In this example, portable case 1014, such as a hard-plastic shell case, contains analog telephonic device 1002, VoIP adapter 1010, wireless access control unit 1022, battery 1012 and antenna 1004. A battery charger to charge battery 1012 may also selectively attach to a connection on the outside of the portable case and an AC outlet or a vehicle lighter outlet.

Within portable case 1014, telephonic device 1002, battery 1012, and wireless access control unit 1022 are connected with VoIP adapter 1010. VoIP adapter 1010 employed may be an analog telephone adapter (ATA). Telephonic device 1002, for example, may be an analog telephone that is coupled by telephone cable 1082 with VoIP adapter 1010 to establish an analog telephone line. Ethernet cable 1084 connects VoIP adapter 1010 to wireless access control unit 1022 to establish network communication to and from VoIP adapter. One or more power cables 1086 may be employed to provide power from battery 1012 to VoIP adapter 1010 and wireless access control unit 1022. As an example, a 12 volt, 12 amp hour battery may be used. Coaxial cable 1006 may be used to connect wireless access control unit 1022 with antenna 1004, such as an 8 dBi antenna. Antenna 1004 may also be attached to wireless access control unit 1022 via a hinged swing-arm antenna mount for automatically positioning itself for use.

Wireless access control unit 1022 is used to provide network connectivity. Wireless access control unit 1022 may, for example, be a wireless modem card that is pre-configured in order to identify the telephonic device 1002 as being an authenticated network device for communication with other network devices of a wireless local area network 740, FIG. 7. For example, an ISM (Industrial, Scientific, Manufacturing) mobile broadband modem may be employed as a wireless access control unit. Wireless access control unit 1022, FIG. 11, provides wireless communication to other network devices or nodes of a wireless local area network 740, FIG. 7, that has connectivity to external data networks such as the Internet.

In use, a user operates the telephonic devices 702, 1002 as they would normally be used. Voice mail, caller ID, call forwarding and other telephone features operate in regular fashion. As an alternative to an analog telephone, a facsimile machine, fax/printer/scanner/copier machine, or any other analog telephony devices may be used as a telephonic device 702, 1002. The VoIP communication system embodiments shown provide for portable, quickly-deployable, voice and facsimile communication for wireless broadband tactical networking “in the field”. The VoIP communication system may securely and seamlessly transmit voice or facsimile data to and from network users, even when the system is used in a vehicle traveling at speeds in excess of 100 mph. The VoIP communication system embodiments provide communication independent of network topology, having the ability to integrate with mobile, ad-hoc, and mesh networks or other structured network environments using TCP/IP configurable Protocol. Voice and facsimile communications are available to the user at various locations and vehicle speeds, as well as automatic transparent authentication and network access. Mobile, secure, broadband voice and fax communications are provided using VoIP technology.

Variations, modifications and other implementations of what is described herein will occur to those of ordinary skill in the art without departing from the spirit and scope of the invention. For example, four port switch 211 may reside on other components within system, including network management server 212. Accordingly, the invention is in no way limited by the preceding illustrative description.

The foregoing description of the preferred embodiments of the invention have been presented for purposes of illustration and description, and are not intended to be exhaustive or to limit the invention the precise forms disclosed. The descriptions were selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A deployable Voice over Internet Protocol (VoIP) communication system for providing VoIP communication to external communication devices via a data network comprising:
a plurality of wireless telephonic devices;
an antenna coupled with a base station, the antenna adapted for wireless communication with the wireless telephonic devices;
a VoIP adapter coupled with the base station, the VoIP adapter adapted to provide a telephonic line upon obtaining network connectivity; and
a power supply having a plurality power outputs to provide power to the base station and the VoIP adapter.

2. The deployable VoIP communication system of claim 1, further comprising a wireless router coupled with the VoIP adapter, the wireless router adapted for wireless transmission of data packets received from the VoIP adapter.

3. The deployable VoIP communication system of claim 2, wherein the power supply has a DC power output to provide DC power to the wireless router.

4. The deployable VoIP communication system of claim 3, further comprising a portable stand that mounts the wireless router and the antenna.

5. The deployable system of claim 2, wherein the wireless router is pre-configured for identification as a network device of a wireless local area network.

6. The deployable system of claim 5, wherein the wireless local area network is at least one of: (a) a mobile network, (b) an ad-hoc network, and (c) a mesh network.

7. The deployable system of claim 2, wherein the wireless router is adapted to communicate with an access point of a network communication system, the network communication system having a control unit coupled with the access point and with a satellite dish, the satellite dish adapted to communicate with an airborne satellite for connectivity to the Internet.

8. The deployable VoIP communication system of claim 1, further comprising a network cable for coupling the VoIP adapter with a control unit of a network communication system, the control unit coupled with a satellite dish adapted to communicate with an airborne satellite for connectivity to the Internet.

9. The deployable VoIP communication system of claim 1, wherein network connectivity is provided by coupling the VoIP adapter to a computer device having connectivity to the Internet.

10. The deployable VoIP communication system of claim 1, further comprising a plurality of VoIP adapters, and
a portable case in which the base station, the VoIP adapters, and the power supply are fixedly housed within the portable case.

11. The deployable VoIP communication system of claim 10, wherein the power supply has a plurality of power inputs for receipt of power from both an AC power source and a DC power source.

12. The deployable VoIP communication system of claim 11, wherein the base station and at least one of the VoIP adapters are hardwired to the power supply.

13. The deployable VoIP communication system of claim 12, further comprising a plurality of charging units hardwired to the power supply and fixedly housed within the portable case, the charging units being adapted to charge the wireless telephonic devices.

14. The deployable VoIP communication system of claim 11, wherein the plurality wireless telephonic devices are analog handsets.

15. The deployable VoIP communication system of claim 14, wherein the antenna is an extended range antenna for providing wireless communication with the analog handsets at distances in excess of one mile.

16. The deployable VoIP communication system of claim 15, further comprising an antenna cable coupling the extended range antenna with the base station.

17. The deployable VoIP communication system of claim 15, wherein the base station is a private branch exchange (PBX) device.

18. The deployable VoIP communication system of claim 14, further comprising a patch panel having a network connection port coupled with at least one of the VoIP adapters, an AC power port coupled with the power supply, a DC power port coupled with the power supply, and antenna port coupled with the base station.

19. The deployable VoIP communication system of claim 18, wherein the patch panel is placed at a sidewall of the portable case.

20. The deployable VoIP communication system of claim 18, further comprising an uninterruptible power supply (UPS) battery coupled with the power supply.

21. A Voice over Internet Protocol (VoIP) communication system for providing VoIP communication to external communication devices via a data network comprising:
a telephonic device coupled with a VoIP adapter;
a wireless access control unit coupled with the VoIP adapter to provide network connectivity to the VoIP adapter, the VoIP adapter adapted to provide a telephonic line upon obtaining network connectivity; and
a power source coupled with the wireless access control unit and the VoIP adapter to provide power to the wireless access control unit and the VoIP adapter.

22. The VoIP communication system of claim 21, further comprising a portable case housing the telephonic device, the wireless access control unit, the VoIP adapter and the power source.

23. The VoIP communication system of claim 21, wherein the wireless access control unit is adapted to communicate with a wireless local area network having connectivity to the Internet.

24. The VoIP communication system of claim 23, wherein the wireless local area network is at least one of: (a) a mobile network, (b) an ad-hoc network, and (c) a mesh network.

25. The VoIP communication system of claim 23, wherein the wireless access control unit is a mobile broadband modem device.

26. The VoIP communication system of claim 23, further comprising an Ethernet cable coupling the wireless access control unit to the VoIP adapter.

27. The VoIP communication system of claim 26, further comprising an antenna coupled with the wireless access control unit by a coaxial cable.

28. The VoIP communication system of claim 26, wherein the power source is a battery, and in which the battery, VoIP adapter, and wireless access control unit are housed within a portable case.
